(19) United States
(12) Patent Application Publication
(10) Pub. No.: US 2021/0135300 A1
(43) Pub. Date: May 6, 2021

(54) BATTERY PACK, WIRELESS POWER TRANSMISSION SYSTEM, AND HEARING AID

(71) Applicant: NITTO DENKO CORPORATION, Ibaraki-shi, Osaka (JP)

(72) Inventors: Taiki SUEYOSHI, Osaka (JP); Masami INOUE, Osaka (JP); Hisashi TSUDA, Osaka (JP); Takashi ODA, Osaka (JP); Kaoru ITO, Osaka (JP); Hideshi YAMAKAWA, Osaka (JP); Daigo TSUBAI, Osaka (JP); Toru MIZUTANI, Osaka (JP); Yasuyuki OTA, Osaka (JP)

(73) Assignee: NITTO DENKO CORPORATION, Ibaraki-shi, Osaka (JP)

(21) Appl. No.: 16/492,486

(22) PCT Filed: Mar. 28, 2018
(86) PCT No.: PCT/JP2018/012840

§ 371 Date: Sep. 9, 2019

(30) Foreign Application Priority Data
Mar. 31, 2017 (JP) 2017-071241
Jul. 31, 2017 (JP) 2017-148219

(51) Int. Cl. H01M 10/46; H02J 7/00; H02J 50/12; H02J 50/00; H02J 7/02; H04R 25/00

(52) U.S. Cl. CPC H01M 10/46; H02J 7/0042; H02J 50/12; H04R 2225/31; H02J 7/02; H04R 25/602; H02J 2310/23; H02J 50/005

(57) ABSTRACT

A battery pack includes a secondary battery having a battery negative electrode terminal disposed at one side in thickness direction of the secondary battery and a battery positive electrode terminal disposed at the other side in thickness direction of the secondary battery; a coil member; a circuit board electrically connected with the battery negative electrode terminal, the battery positive electrode terminal, and the coil member; and a housing accommodating the secondary battery, the coil member, and the circuit board, wherein the battery negative electrode terminal is exposed to the outside of the housing.

### TECHNICAL FIELD

The present invention relates to a battery pack, and a wireless power transmission system and a hearing aid including the battery pack.

### BACKGROUND ART

Conventionally, a wirelessly chargeable secondary battery unit has been known. Such a secondary battery unit can be wirelessly charged using a matching charger while the unit is attached to the electronic device, and therefore it is highly convenient.

Patent Document 1 discloses, for example, such a secondary battery unit. The battery unit described in Patent Document 1 includes a secondary battery; a power-receiving coil that receives electric power supplied from outside; a circuit board that charges the secondary battery using the electric power received; a case accommodating the secondary battery, power-receiving coil, and circuit board; a positive electrode output terminal provided at a position corresponding to the positive electrode of the secondary battery; and a negative electrode output terminal provided at a position corresponding to the negative electrode of the secondary battery.

### CITATION LIST

### Patent Document

### Patent Document 1: Japanese Unexamined Patent Publication No. 2015-88376

### SUMMARY OF THE INVENTION

### Problem to be Solved by the Invention

The battery unit has been examined for use in small devices such as a hearing aid, and therefore a smaller size is required for the battery unit.

However, the battery unit of Patent Document 1 includes the positive electrode output terminal provided at the positive electrode side of the primary battery, and the negative electrode output terminal provided at the negative electrode side of the primary battery. That is, the positive electrode output terminal and the negative electrode output terminal are provided at one side in the thickness direction of the battery unit and an opposite side thereof. Therefore, the battery unit has a thickness of, in addition to the secondary battery, power-receiving coil, and case, two more terminals. Therefore, further reduction in size is required.

The present invention provides a battery pack that can be made into a small size, a wireless power transmission system, and a hearing aid.

### Means for Solving the Problem

The present invention [1] includes a battery pack including: a secondary battery having a battery negative electrode terminal disposed at one side in thickness direction of the secondary battery and a battery positive electrode terminal disposed at the other side in thickness direction of the secondary battery; a coil member; a circuit board electrically connected with the battery negative electrode terminal, the battery positive electrode terminal, and the coil member; and a housing accommodating the secondary battery, the coil member, and the circuit board, wherein the battery negative electrode terminal is exposed to the outside of the housing.

With the battery pack, the battery negative electrode terminal is exposed from the housing, and therefore when the external electronic device is attached to the battery pack, the negative electrode terminal of the external electronic device can be directly brought into contact with the battery negative electrode terminal in the battery pack. In this manner, they are electrically connected to drive the external electronic device. Therefore, a terminal that makes contact with a negative electrode terminal of the external electronic device does not have to be provided separately, and therefore a smaller size can be achieved.

The present invention [2] includes the battery pack described in [1], wherein the coil member is a sheet coil including an insulating layer and a coiled wire disposed on at least one surface of the insulating layer.

With the battery pack, the coil member is a sheet coil, and therefore the size in the thickness direction is smaller than the case of a wound coil where copper wires are wound. Therefore, a smaller size can be achieved even more.

The present invention [3] includes the battery pack described in [1] or [2], wherein the circuit board is a flexible wired circuit board including a control element.

With the battery pack, the circuit board is a flexible wired circuit board, and therefore it has flexibility. Therefore, the circuit board can be freely disposed in the housing in accordance with the shapes of the housing and secondary battery, and the space in the housing can be effectively used. Therefore, a smaller size can be achieved even more.

The present invention [4] includes the battery pack described in any one of [1] to [3], further including a magnetic sheet disposed between the coil member and the circuit board.

With the battery pack, the magnetic sheet is included, and therefore when the coil member receives electric power externally, the electric power can be converged to the coil member. Therefore, electric power receiving efficiency can be improved.

The present invention [5] includes the battery pack described in any one of [1] to [4], wherein the housing has a first opening to expose the battery negative electrode terminal at one side in thickness direction of the secondary battery.

With the battery pack, the negative electrode terminal of the external electronic device can be reliably brought into contact with the battery negative electrode terminal in the first opening.

The present invention [6] includes the battery pack described in any one of [1] to [5], wherein the circuit board further includes a first circuit terminal that is electrically connected with the battery positive electrode terminal, and a second circuit terminal that is electrically connected with the battery negative electrode terminal.

With the battery pack, the first circuit terminal connected to the battery positive electrode terminal and the second circuit terminal connected to the battery negative electrode terminal are included, and therefore the secondary battery can be reliably charged through the first circuit terminal and the second circuit terminal.

The present invention [7] includes the battery pack described in [6], wherein the housing has a second opening for accommodating the second circuit terminal at one side in thickness direction of the secondary battery.

With the battery pack, the second circuit terminal is accommodated in the second opening of the housing, and therefore the second circuit terminal does not have to be provided in one side in thickness direction of the housing. Therefore, a thinner size can be achieved even more.

The present invention [8] includes a wireless power transmission system including the battery pack described in any one of [1] to [7], and a power-supplying device including a power-supplying coil.

With the wireless power transmission system, by driving the power-supplying device, electric power can be transmitted wirelessly to the secondary battery of the battery pack, and therefore the secondary battery can be wirelessly charged.

The present invention [9] includes the wireless power transmission system described in [8], wherein the power-supplying device transmits electric power with a frequency of 1 MHz or more and 10 MHz or less.

With the wireless power transmission system, the battery pack can receive electric power with a high frequency of 1 MHz or more and 10 MHz or less. Therefore, the secondary battery can be charged highly efficiently.

The present invention [10] includes a hearing aid including the battery pack described in any one of [1] to [7]; a hearing aid housing having an accommodation unit that accommodates the battery pack; and a microphone, an amplifier, and a speaker provided inside the hearing aid housing.

The hearing aid allows for size reduction of the accommodation unit, and therefore the hearing aid can be made small.

The present invention [11] includes the hearing aid described in [10], wherein the accommodation unit is capable of accommodating a primary battery.

The hearing aid can be driven by any of the primary battery and secondary battery, and therefore has excellent convenience.

### Effects of the Invention

The battery pack, wireless power transmission system, and hearing aid of the present invention can be made into a small size.

### BRIEF DESCRIPTION OF THE DRAWINGS

FIG. 1 shows a perspective view of the battery pack in an embodiment of the present invention.

FIGS. 2A-B are developed view of the coil-included board used for the battery pack shown in FIG. 1: FIG. 2A is a plan view and FIG. 2B is a bottom view.

FIG. 3 shows cross sectional view taken along A-A of the coil-included board in FIG. 2A.

FIG. 4 shows a housing used in the battery pack shown in FIG. 1: FIG. 4A is a plan view, FIG. 4B is a side view, and FIG. 4C is a bottom view.

FIG. 5 shows an exploded perspective view of the battery pack shown in FIG. 1.

FIGS. 6A-B show the battery pack shown in FIG. 1: FIG. 6A is a plan view and FIG. 6B is a bottom view.

FIGS. 7A-B show the battery pack shown in FIG. 6A: FIG. 7A is a cross sectional view taken along A-A, and FIG. 7B is a cross sectional view taken along B-B.

FIGS. 8A-B show enlarged views of a first folding portion of the first joint base portion shown in FIG. 1: FIG. 8A is a cross sectional view taken along front-rear direction, and FIG. 8B is a cross sectional view taken along left-right direction.

FIG. 9 shows a block diagram of the wireless power transmission system in an embodiment of the present invention.

FIG. 10 shows exploded perspective views of the hearing aid in an embodiment of the present invention: FIG. 10A shows an open state, and FIG. 10B shows a closed state.

FIGS. 11A-B show an embodiment in which the secondary battery is a tabbed battery: FIG. 11A is a perspective view seen from the upper side, and FIG. 11B is a perspective view seen from the lower side.

FIG. 12 shows an exploded perspective view of the battery pack in which the secondary battery of FIG. 11A is used.

FIG. 13 shows a plan view of the battery pack shown in FIG. 12.

### DESCRIPTION OF THE EMBODIMENTS

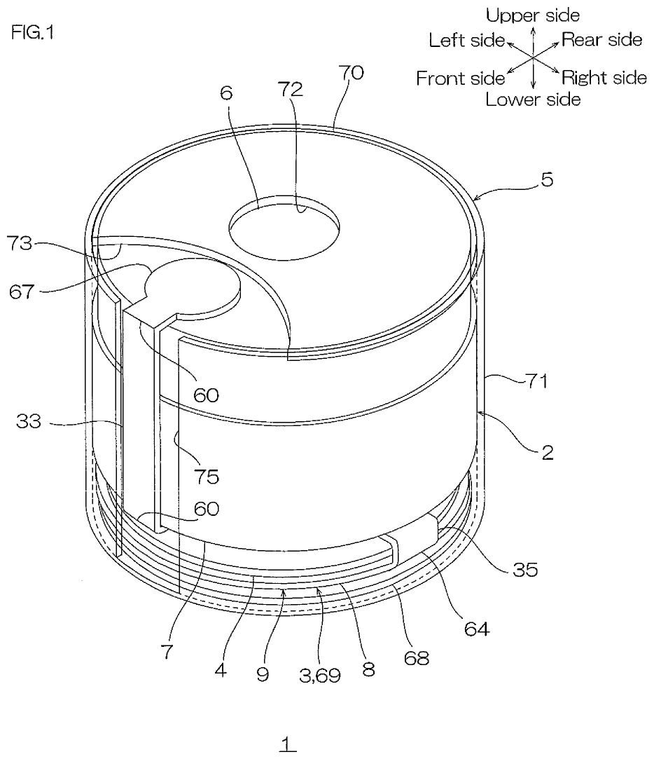

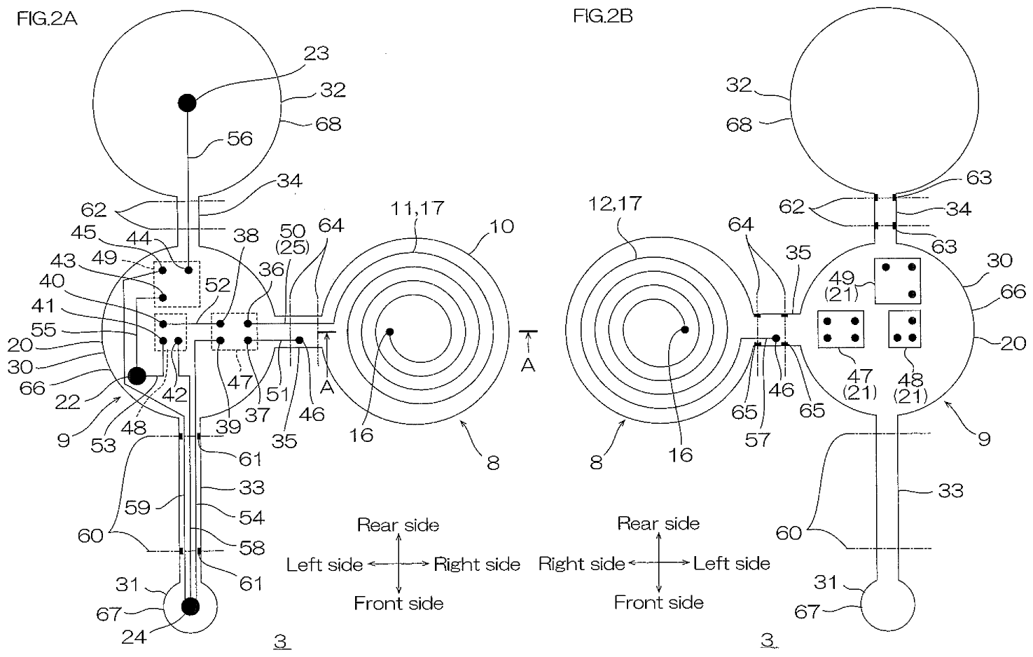

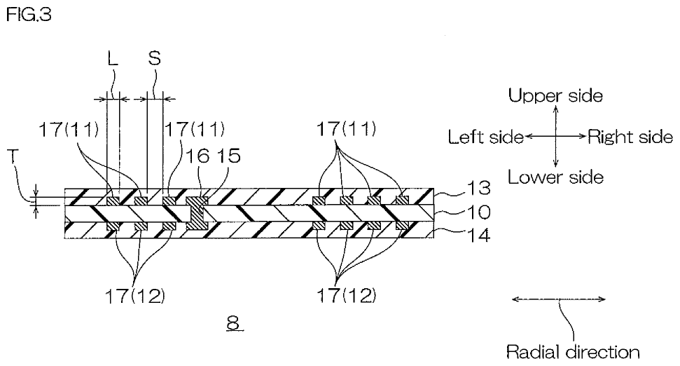

An embodiment of the present invention is described below with reference to drawings. In FIG. 3, the up-down direction on paper surface is up-down direction (thickness direction, first direction), upper side on paper surface is upper side (one side in thickness direction, one side in first direction), and lower side on paper surface is lower side (the other side in thickness direction, the other side in first direction). In FIG. 3, left-right direction on paper surface is left-right direction (second direction orthogonal to first direction), left side on paper surface is left side (one side in second direction), and right side on paper surface is right side (the other side in second direction). In FIG. 3, paper-thickness direction is front-rear direction (third direction orthogonal to first direction and second direction), near side on paper surface is front side (one side in third direction), and far side on paper surface is rear side (the other side in third direction). To be specific, directions are in accordance with the direction arrows in the figures. In FIG. 1, the housing is transparent. In FIG. 2A and FIG. 2B, the first insulating cover layer, second insulating cover layer, and third insulating cover layer are omitted.

<Battery Pack>

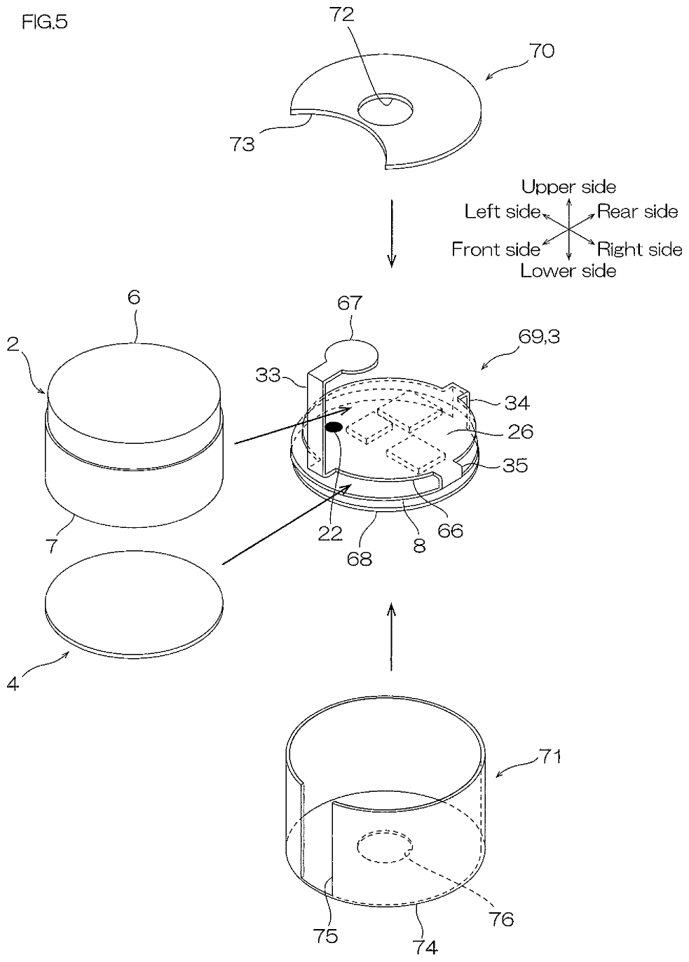

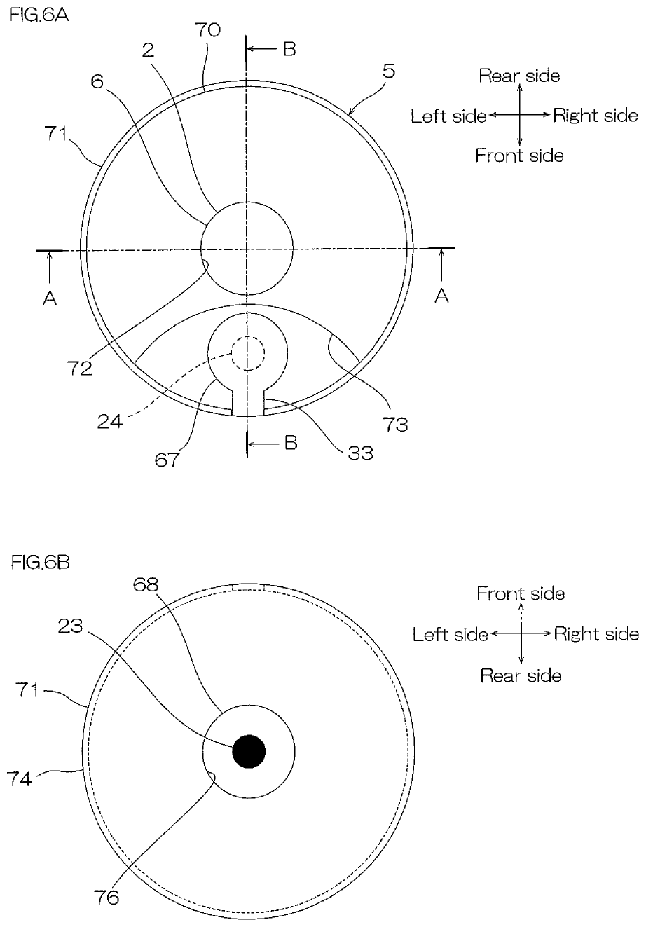

With reference to FIG. 1A to FIG. 8B, the battery pack in one embodiment of the present invention is described. As shown in FIGS. 1 and 5, the battery pack 1 includes a secondary battery 2, coil-included board 3, magnetic sheet 4, and housing 5. These components are described below.

(Secondary Battery)

As shown in FIG. 5, the secondary battery 2 is a battery capable of charging and discharging, and has a substantially cylindrical shape (particularly, button shape). The secondary battery 2 is leveled in up-down direction, with its upper portion slightly smaller in diameter than that of the lower portion.

The secondary battery 2 includes a battery negative electrode terminal 6 and a battery positive electrode terminal 7.

The battery negative electrode terminal 6 is disposed at the upper side of the secondary battery 2. To be specific, the battery negative electrode terminal 6 is formed at the upper face of the secondary battery 2, and the peripheral side face of the upper portion.

The battery positive electrode terminal 7 is disposed at the lower side of the secondary battery 2. To be specific, the battery positive electrode terminal 7 is formed at the lower face of the secondary battery 2, and the peripheral side face of the lower portion.

Examples of the secondary battery 2 include, to be specific, a lithium ion secondary battery, nickel hydrogen secondary battery, and silver zinc secondary battery.

(Coil-Included Board)

As shown in FIG. 2A and FIG. 2B (developed view), the coil-included board 3 integrally includes a coil member 8 and circuit board 9.

The coil member 8 is a sheet coil: it is a power-receiving coil that receives electric power supplied from a power-supplying device to be described later. To be specific, it is a power-receiving coil that is capable of generating electricity based on the magnetic field generated by the power-supplying coil to be described later.

As shown in FIG. 3, the coil member 8 includes a first insulating base layer 10 as the insulating layer, first coil pattern 11, second coil pattern 12, first coil insulating cover layer 13, and second coil insulating cover layer 14.

As shown in FIG. 2A to FIG. 3, the first insulating base layer 10 has the outline shape of the coil member 8, and has a generally circular shape in plan view.

At a generally center in plan view of the first insulating base layer 10, a via opening 15 penetrating in up-down direction (thickness direction) is formed. At the via opening 15, a coil via portion 16 composed of metal conductive portion is disposed. The coil via portion 16 is exposed at the upper face and the lower face of the first insulating base layer 10. The coil via portion 16 is integrally formed with and electrically connects the first coil pattern 11 and the second coil pattern 12.

The first insulating base layer 10 is formed from, for example, insulating materials such as synthetic resin including polyimide resin, polyamide-imide resin, acrylic resin, polyether nitrile resin, polyether sulfone resin, polyethylene terephthalate resin, polyethylene naphthalate resin, and poly vinyl chloride resin. Preferably, it is formed from polyimide resin.

The first insulating base layer 10 has a thickness of, for example, 1 μm or more, preferably 5 μm or more, and for example, 100 μm or less, preferably 60 μm or less.

The first coil pattern 11 is disposed at the upper face of (upper side surface) the first insulating base layer 10. To be specific, the first coil pattern 11 is disposed at the upper side of the first insulating base layer 10 so that the lower face of the first coil pattern 11 is brought into contact with the upper face of the first insulating base layer 10. The first coil pattern 11 is a coiled wire pattern composed of wires 17.

As shown in FIG. 2A, the first coil pattern 11 is formed into a swirl shape headed from the coil via portion 16 to the outside in radial direction in plan view. The first coil pattern 11 is formed into a swirl shape reaching the peripheral end near the third joint base portion 35, and at the peripheral end near the third joint base portion 35, it is formed into a linier shape heading toward the outside (left side).

As shown in FIG. 3, the cross sectional shape of the wire 17 forming the first coil pattern 11 along the radial direction is formed into a generally rectangular shape.

The second coil pattern 12 is disposed at the lower face (lower side surface) of the first insulating base layer 10. To be specific, the second coil pattern 12 is disposed at the lower side of the first insulating base layer 10 so that the upper face of the second coil pattern 12 is in contact with the lower face of the first insulating base layer 10. The second coil pattern 12 is a coiled wire pattern composed of wires 17.

As shown in FIG. 2B, the second coil pattern 12 is formed into a swirl shape headed from the coil via portion 16 to the outside in radial direction in bottom view. The second coil pattern 12 is formed into a swirl shape reaching the peripheral end near the third joint base portion 35, and at the peripheral end near the third joint base portion 35, it is formed into a linear shape headed toward the outside (left side).

The cross sectional shape of the wire 17 forming the second coil pattern 12 along the radial direction is formed into a generally rectangular shape.

Examples of the material forming the wire 17 include conductive metals such as copper, silver, gold, nickel, solder, and alloys thereof. Preferably, copper is used.

The bottom view shape (swirl shape pattern) at the intermediate portion of the second coil pattern 12 is substantially the same as the plan view shape at the intermediate portion of the first coil pattern 11. That is, the width L of the wires 17 of the second coil pattern 12 and the space S between the wires 17 are substantially the same as the width L and the space S of the wire 17 of the first coil pattern 11, and the number of winding of the second coil pattern 12 is the same as the number of the winding of the first coil pattern 11.

In the first coil pattern 11 and second coil pattern 12, the width L (radial direction length of wire 17) of the wire 17 is, for example, 5 μm or more, preferably 20 μm or more, and for example, 400 μm or less, preferably 200 μm or less.

In the first coil pattern 11 and second coil pattern 12, the thickness T of the wire 17 is, for example, 3 μm or more, preferably 10 μm or more, and for example, 200 μm or less, preferably 100 μm or less.

In the first coil pattern 11 and second coil pattern 12, the space S (radial direction length between the wires 17 adjacent to each other) between the wires 17 is, for example, 5 μm or more, preferably 20 μm or more, and for example, 400 μm or less, preferably 200 μm or less.

In the first coil pattern 11 and second coil pattern 12, the coil is wound by a number of, for example, 1 or more, preferably 3 or more, and for example, 500 or less, preferably 300 or less.

The first coil insulating cover layer 13 is disposed at the upper face of the first coil pattern 11. To be specific, the first coil insulating cover layer 13 is disposed at the upper side of the first coil pattern 11 and first insulating base layer 10 so as to cover the upper face and the side face of the first coil pattern 11, and the upper face of the first insulating base layer 10 not covered with the first coil pattern 11.

The first coil insulating cover layer 13 has a generally circular shape in plan view. When projected in up-down direction, the first coil insulating cover layer 13 includes the first coil pattern 11, and the first coil insulating cover layer 13 is included in the first insulating base layer 10.

The second coil insulating cover layer 14 is disposed at the lower face of the second coil pattern 12. To be specific, the second coil insulating cover layer 14 is disposed at the lower side of the second coil pattern 12 and first insulating base layer 10 so as to cover the lower face and side face of the second coil pattern 12, and the lower face of the first insulating base layer 10 not covered with the second coil pattern 12.

The second coil insulating cover layer 14 has a generally circular shape in plan view. The second coil insulating cover layer 14 includes the second coil pattern 12, and the second coil insulating cover layer 14 is included in the first insulating base layer 10 when projected in up-down direction.

The first coil insulating cover layer 13 and the second coil insulating cover layer 14 are formed from the material that is the same as that of the above-described insulating material for the first insulating base layer 10, and preferably, formed from polyimide resin.

The first coil insulating cover layer 13 and second coil insulating cover layer 14 has a thickness of, for example, 2 μm or more, preferably 5 μm or more, and for example, 70 μm or less, preferably 60 μm or less.

The circuit board 9 is a flexible wired circuit board having flexibility, and is disposed at the left side of the coil member 8 to be continuous therefrom.

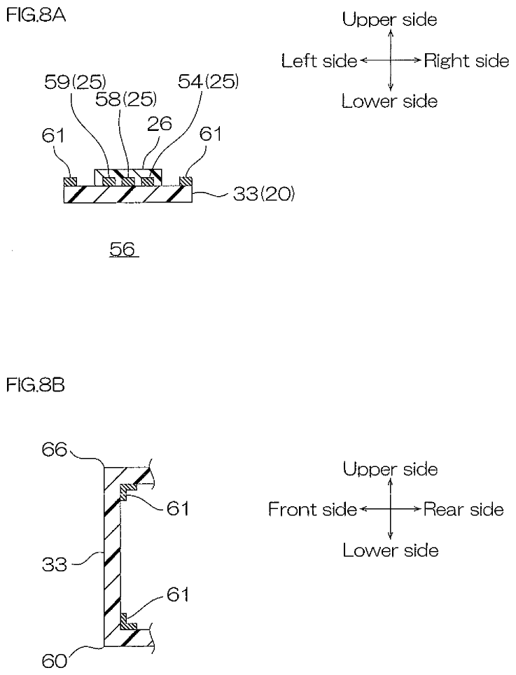

The circuit board 9 includes, as shown in FIG. 2A, FIG. 2B and FIG. 8A, a second insulating base layer 20, control element 21, battery-side circuit positive electrode terminal 22 as the first circuit terminal, external-side circuit positive electrode terminal 23, charging-circuit negative electrode terminal 24 as the second circuit terminal, connection wire pattern 25, and third insulating cover layer 26.

The second insulating base layer 20 includes the control circuit base portion 30, negative electrode terminal base portion 31, positive electrode terminal base portion 32, first joint base portion 33, second joint base portion 34, and third joint base portion 35.

The control circuit base portion 30 is an insulating base portion for mounting the control element 21 (described later), and is disposed at a generally center in plan view of the circuit board 9. The control circuit base portion 30 has a generally circular shape in plan view, and is formed to be a slightly smaller than the first insulating base layer 10.

At the control circuit base portion 30, a plurality of base via portions (first to tenth via portions 36 to 45) that electrically connect the connection wire pattern 25 (first to tenth connection wires 50 to 59 to be described later) with the control element 21 (rectifier 47, charge controller 48, transformer 49 to be described later) are formed. To be specific, the following is formed: the first via portion 36 for connecting the rectifier 47 with the first connection wire 50 in up-down direction, second via portion 37 for connecting the rectifier 47 with the second connection wire 51 in up-down direction, third via portion 38 for connecting the rectifier 47 with the third connection wire 52 in up-down direction, fourth via portion 39 for connecting the rectifier 47 with the fifth connection wire 54 in up-down direction, fifth via portion 40 for connecting the charge controller 48 with the third connection wire 52 in up-down direction, sixth via portion 41 for connecting the charge controller 48 with the fourth connection wire 53 in up-down direction, seventh via portion 42 for connecting the charge controller 48 with the ninth connection wire 58 in up-down direction, eighth via portion 43 for connecting the transformer 49 with the sixth connection wire 55 in up-down direction, ninth via portion 44 for connecting the transformer 49 with the seventh connection wire 56 in up-down direction, and tenth via portion 45 for connecting the transformer 49 with the tenth connection wire 59 in up-down direction. At each of the base via portions 36 to 45, a via opening penetrating the second insulating base layer 20 in up-down direction is formed, and the metal conductive portion is disposed at the via opening.

The negative electrode terminal base portion 31 is an insulating base portion for disposing the charging-circuit negative electrode terminal 24, and is disposed at the front side of the control circuit base portion 30 in spaced apart relation. The negative electrode terminal base portion 31 has a generally circular shape in plan view, and is formed to be smaller than the control circuit base portion 30.

The positive electrode terminal base portion 32 is an insulating base portion for disposing the external-side circuit positive electrode terminal 23, and is disposed at the rear side of the control circuit base portion 30 in spaced apart relation. The positive electrode terminal base portion 32 has a generally circular shape in plan view, and is formed to be the same shape as that of the first insulating base layer 10.

The first joint base portion 33 is an insulating base portion for connecting the control circuit base portion 30 with the negative electrode terminal base portion 31, and is disposed at the front side of the control circuit base portion 30. To be specific, the first joint base portion 33 is disposed between the negative electrode terminal base portion 31 and the control circuit base portion 30 so that the front end thereof is integrally continuous with the negative electrode terminal base portion 31 and the rear end thereof is integrally continuous with the control circuit base portion 30. The first joint base portion 33 is formed into a generally rectangular shape extending in front-rear direction in plan view.

Along the front-rear direction of the first joint base portion 33, a plurality of (two) first bending portions 60 are formed in spaced apart relation in front-rear direction. The first bending portion 60 extends linearly from the left end edge to the right end edge in left-right direction. The first bending portions 60 can be bent to form the right angle toward the upper side.

The two first bending portions 60 are each provided with a plurality of (two) first bent-fixing portion 61. The first bent-fixing portion 61 is formed into a generally rectangular shape in plan view. Each of the first bent-fixing portions 61 is disposed at the left end edge or the right end edge of the upper face of the first joint base portion 33 across the first bending portion 60 in front-rear direction.

The first bent-fixing portion 61 is formed from metal foil including copper foil, nickel foil, silver foil, gold foil, or foil of alloys thereof. Preferably, copper foil is used.

The first bent-fixing portion 61 has a thickness of, for example, 3 μm or more, preferably 10 μm or more, and for example, 200 μm or less, preferably 100 μm or less.

The second joint base portion 34 is an insulating base portion for connecting the control circuit base portion 30 with the positive electrode terminal base portion 32, and is disposed at the rear side of the control circuit base portion 30. To be specific, the second joint base portion 34 is disposed between the control circuit base portion 30 and the positive electrode terminal base portion 32 so that the front end thereof is integrally continuous with the control circuit base portion 30, and the rear end thereof is integrally continuous with the positive electrode terminal base portion 32. The second joint base portion 34 is formed into a generally rectangular shape extending in front-rear direction in plan view.

Along the front-rear direction of the second joint base portion 34, a plurality of (two) second bending portions 62 are formed in spaced apart relation in front-rear direction. The second bending portion 62 extends linearly from the left end edge to the right end edge in left-right direction. The second bending portion 62 can be bent to form the right angle toward the lower side.

The two second bending portions 62 are each provided with a plurality of second bent-fixing portion 63. The second bent-fixing portion 63 is formed into a generally rectangular shape in bottom view. Each of the second bent-fixing portions 63 is disposed at the left end edge or the right end edge at the lower face of the second joint base portion 34 across the second bending portion 62 in front-rear direction.

The material and the thickness of the second bent-fixing portion 63 are the same as the material and the thickness of the first bent-fixing portion 61.

The third joint base portion 35 is an insulating base portion for connecting the control circuit base portion 30 with the first insulating base layer 10, and is disposed at the right side of the control circuit base portion 30. To be specific, the third joint base portion 35 is disposed between the control circuit base portion 30 and the first insulating base layer 10 so that the left end thereof is integrally continuous with the control circuit base portion 30 and the right end thereof is integrally continuous with the first insulating base layer 10. The third joint base portion 35 is formed into a generally rectangular shape extending in left-right direction in plan view.

Along the left-right direction of the third joint base portion 35, a plurality of (two) third bending portions 64 are formed in spaced apart relation in left-right direction. The third bending portion 64 extends linearly from the front end edge to the rear end edge in front-rear direction. The third bending portion 64 can be bent to form the right angle toward the lower side.

The two third bending portions 64 are each provided with a plurality of (two) third bent-fixing portion s 65. The third bent-fixing portion 65 is formed into a generally rectangular shape in bottom view. Each of the third bent-fixing portions 65 is disposed at the front end edge or the rear end edge of the lower face of the third joint base portion 35 across the third bending portion 64 in left-right direction.

The material and the thickness of the third bent-fixing portion 65 are the same as the material and the thickness of the first bent-fixing portion 61.

At the third joint base portion 35, an eleventh via portion 46 for connecting the second connection wire 51 and eighth connection wire 57 in up-down direction is formed. At the eleventh via portion 46, a via opening penetrating the second insulating base layer 20 in up-down direction is formed, and the metal conductive portion is disposed at the via opening.

The battery-side circuit positive electrode terminal 22 is a terminal for supplying the electric current from the coil member 8 to the battery positive electrode terminal 7 of the secondary battery 2 at the time of charging, and a terminal for supplying the electric current from the battery positive electrode terminal 7 through the external-side circuit positive electrode terminal 23 to the positive electrode terminal (for example, external device positive electrode terminal 97 to be described later) of the external electronic device (for example, hearing aid 90 to be described later) at the time of discharging.

The battery-side circuit positive electrode terminal 22 is disposed to directly contact the battery positive electrode terminal 7 of the secondary battery 2. To be specific, the battery-side circuit positive electrode terminal 22 is disposed at the upper face and the left front portion of the control circuit base portion 30. The battery-side circuit positive electrode terminal 22 has a generally circular shape in plan view.

The external-side circuit positive electrode terminal 23 is a terminal for supplying the electric current from the secondary battery 2 to the positive electrode terminal of the external electronic device at the time of discharging.

The external-side circuit positive electrode terminal 23 is disposed so as to directly contact the positive electrode terminal of the external electronic device. To be specific, the external-side circuit positive electrode terminal 23 is disposed at the upper face and a generally center in plan view of the positive electrode terminal base portion 32. The external-side circuit positive electrode terminal 23 has a generally circular shape in plan view.

The charging-circuit negative electrode terminal 24 is a terminal for supplying electric current from the coil member 8 to the battery negative electrode terminal 6 of the secondary battery 2 at the time of charging.

The charging-circuit negative electrode terminal 24 is disposed to directly contact the battery negative electrode terminal 6 of the secondary battery 2. To be specific, the charging-circuit negative electrode terminal 24 is disposed at the upper face and a generally center in plan view of the negative electrode terminal base portion 31. The charging-circuit negative electrode terminal 24 has a generally circular shape in plan view.

The connection wire pattern 25 is a wire that electrically connects the terminals (22, 23, 24), coil patterns (11, 12), and control element 21. The connection wire pattern 25 includes a first connection wire 50, second connection wire 51, third connection wire 52, fourth connection wire 53, fifth connection wire 54, sixth connection wire 55, seventh connection wire 56, eighth connection wire 57, ninth connection wire 58, and tenth connection wire 59.

The first connection wire 50 electrically connects the first coil pattern 11 with the rectifier 47. That is, one end of the first connection wire 50 is connected to the first coil pattern 11, and the other end thereof is connected to the first via portion 36. To be specific, the first connection wire 50 is disposed so as to reach from the right end of the upper face of the third joint base portion 35 to the right end of the upper face of the control circuit base portion 30.

The second connection wire 51 electrically connects the second coil pattern 12 with the rectifier 47 through the eighth connection wire 57 and eleventh via portion 46. That is, one end of the second connection wire 51 is connected to the second via portion 37, and the other end thereof is connected to the eleventh via portion 46. To be specific, the second connection wire 51 is disposed to reach from a substantially center of the upper face of the third joint base portion 35 to the right end of the upper face of the control circuit base portion 30, and to be positioned at the front side than the first connection wire 50.

The third connection wire 52 electrically connects the rectifier 47 with the charge controller 48. That is, one end of the third connection wire 52 is connected to the third via portion 38, and the other end thereof is connected to the fifth via portion 40. To be specific, the third connection wire 52 is disposed at substantially a center of the upper face of the control circuit base portion 30.

The fourth connection wire 53 electrically connects the charge controller 48 with the battery-side circuit positive electrode terminal 22. That is, one end of the fourth connection wire 53 is connected with the sixth via portion 41, and the other end thereof is connected with the battery-side circuit positive electrode terminal 22. To be specific, the fourth connection wire 53 is disposed from a substantially center to the left front side at the upper face of the control circuit base portion 30.

The fifth connection wire 54 electrically connects the rectifier 47 with the charging-circuit negative electrode terminal 24. That is, one end of the fifth connection wire 54 is connected to the fourth via portion 39, and the other end thereof is connected to the charging-circuit negative electrode terminal 24. To be specific, the fifth connection wire 54 is disposed so as to reach substantially a center of the upper face of the negative electrode terminal base portion 31 from substantially a center of the upper face of the control circuit base portion 30 through the first joint base portion 33.

The sixth connection wire 55 electrically connects the battery-side circuit positive electrode terminal 22 with the transformer 49. That is, one end of the sixth connection wire 55 is connected to the battery-side circuit positive electrode terminal 22, and the other end thereof is connected to the eighth via portion 43. To be specific, the sixth connection wire 55 is disposed at left side of the upper face of the control circuit base portion 30.

The seventh connection wire 56 electrically connects the transformer 49 with the external-side circuit positive electrode terminal 23. That is, one end of the seventh connection wire 56 is connected to the ninth via portion 44, and the other end thereof is connected to the external-side circuit positive electrode terminal 23. To be specific, the seventh connection wire 56 is disposed to reach substantially a center of the upper face of the positive electrode terminal base portion 32 from the rear end of the upper face of the control circuit base portion 30 through the second joint base portion 34.

The eighth connection wire 57 electrically connects the second coil pattern 12 with the rectifier 47 through the second connection wire 51 and the eleventh via portion 46. That is, one end of the eighth connection wire 57 is connected to the second coil pattern 12, and the other end thereof is connected to the eleventh via portion 46. To be specific, the eighth connection wire 57 is disposed so as to reach the right end from substantially a center at the lower face of the third joint base portion 35.

The ninth connection wire 58 electrically connects the charge controller 48 with the charging-circuit negative electrode terminal 24. That is, one end of the ninth connection wire 58 is connected to the seventh via portion 42, and the other end thereof is connected to the charging-circuit negative electrode terminal 24. To be specific, the ninth connection wire 58 is disposed to reach substantially a center of the upper face of the negative electrode terminal base portion 31 from substantially a center of the upper face of the control circuit base portion 30 through the first joint base portion 33.

The tenth connection wire 59 electrically connects the transformer 49 with the charging-circuit negative electrode terminal 24. That is, one end of the tenth connection wire 59 is connected to the tenth via portion 45, and the other end thereof is connected to the charging-circuit negative electrode terminal 24. To be specific, the tenth connection wire 59 is disposed to reach substantially a center of the upper face of the negative electrode terminal base portion 31 from the rear end of the upper face of the control circuit base portion 30 through the first joint base portion 33.

For the material of the connection wire pattern 25, those materials given as examples for the wire 17 are used. Preferably, copper is used.

The connection wire pattern 25 has a thickness of, for example, 3 μm or more, preferably 10 μm or more, and for example, 200 μm or less, preferably 100 μm or less.

The control element 21 is an element that controls the electric power flowing in the connection wire pattern 25 at the time of charging and discharging. The control element 21 includes a rectifier 47, charge controller 48, and transformer 49.

The rectifier 47 is an element (AC/DC converter) that converts the alternating current supplied from the coil member 8 to the direct current at the time of charging. The rectifier 47 is disposed at the lower face of the control circuit base portion 30, and in bottom view, disposed at the right side of the control circuit base portion 30. The rectifier 47 electrically connects the first connection wire 50, second connection wire 51, third connection wire 52, and fifth connection wire 54.

The charge controller 48 is an element that controls the electric power converted to the direct current at the rectifier 47 and supplies the power to the battery-side circuit positive electrode terminal 22 at the time of charging. The charge controller 48 includes, as necessary, a communication function that monitors charging status of the secondary battery 2, produces a transmission signal, and transmits it to the power-supplying device 81 (described later). The charge controller 48 is disposed at the lower face of the control circuit base portion 30, and in bottom view, disposed at substantially a center of the control circuit base portion 30. The charge controller 48 electrically connects the third connection wire 52 with the fourth connection wire 53.

The transformer 49 is an element that adjusts the voltage from the secondary battery 2 at the time of discharging. The transformer 49 is disposed at the lower face of the control circuit base portion 30, and in bottom view, disposed at the rear side of the control circuit base portion 30. The transformer 49 is electrically connected with the sixth connection wire 55, seventh connection wire 56, and tenth connection wire 59.

The third insulating cover layer 26 is, as shown in FIG. 8A, disposed at the upper side of the second insulating base layer 20 in correspondence with the connection wire pattern 25. To be specific, the third insulating cover layer 26 is disposed at the upper face of the second insulating base layer 20 so as to cover the connection wire pattern 25 and via portions (36 to 46), and not to cover the upper face of the battery-side circuit positive electrode terminal 22, external-side circuit positive electrode terminal 23, and charging-circuit negative electrode terminal 24.

The material and the thickness of the third insulating cover layer 26 are the same as those of the first insulating base layer 10.

Such a coil-included board 3 can be produced by, for example, integrally producing the circuit board 9 apart from the coil member 8 and the control element 21, and then mounting the control element 21 on the circuit board 9.

To be specific, by subtractive method or additive method, on the upper face of the insulating base layers (10, 20), the first coil pattern 11, connection wire pattern 25, battery-side circuit positive electrode terminal 22, external-side circuit positive electrode terminal 23, and charging-circuit negative electrode terminal 24 are formed, and at the lower face of the insulating base layer, the second coil pattern 12 and the connection wire pattern 25 are formed. At this time, the first to third fold-fixing portions (61, 63, 65) are formed at the upper face and the lower face of the insulating base layer simultaneously with those. The via portions (16, 36 to 46) are also simultaneously formed.

Then, the first coil insulating cover layer 13 is formed on the upper face of the first insulating base layer 10 so as to cover the first coil pattern 11. The second coil insulating cover layer 14 is formed on the lower face of the second insulating base layer 20 so as to cover the second coil pattern 12. The third insulating cover layer 26 is formed so as to cover the connection wire pattern 25 and the via portion 36 to 46, and not to cover the battery-side circuit positive electrode terminal 22, external-side circuit positive electrode terminal 23, and charging-circuit negative electrode terminal 24.

Then, at the lower face of the control circuit base portion 30, the control element 21 (rectifier 47, charge controller 48, and transformer 49) is mounted on corresponding base via portions 36 to 45 through solder.

In the circuit board 9, the control circuit base portion 30, control element 21 disposed on the upper face and lower face thereof, battery-side circuit positive electrode terminal 22, connection wire pattern 25, and third insulating cover layer 26 compose a control circuit unit 66. The negative electrode terminal base portion 31, charging-circuit negative electrode terminal 24 disposed at the upper face thereof, connection wire pattern 25, and third insulating cover layer 26 compose a negative electrode terminal unit 67. The positive electrode terminal base portion 32, external-side circuit positive electrode terminal 23 disposed on the upper face thereof, connection wire pattern 25, and third insulating cover layer 26 compose a positive electrode terminal unit 68.

(Magnetic Sheet)

As shown in FIG. 5, the magnetic sheet 4 has a generally circular flat plate shape in plan view, and is formed into the same size and shape as those of the coil member 8 in plan view.

The magnetic sheet 4 is a sheet containing magnetic substance, and for example, a magnetic substance particles-containing resin sheet, and sintered magnetic substance sheet are used.

The magnetic substance particles-containing resin sheet is formed into a sheet shape from a composition containing magnetic substance particles and a resin component.

Examples of the magnetic substance forming the magnetic substance particles include soft magnetic substance and hard magnetic substance, and preferably, soft magnetic substance is used. Examples of the soft magnetic substance include magnetic stainless steel (Fe—Cr—Al—Si alloy), Sendust (Fe—Si—Al alloy), permalloy (Fe—Ni alloy), silicon copper (Fe—Cu—Si alloy), Fe—Si alloy, Fe—Si—B(—Cu—Nb) alloy, Fe—Si—Cr—Ni alloy, Fe—Si—Cr alloy, Fe—Si—Al—Ni—Cr alloy, and ferrite are used.

Examples of the resin component include rubber polymers such as butadiene rubber, styrene-butadiene rubber, isoprene rubber, acrylonitrile rubber, poly acrylate, ethylene-vinyl acetate copolymer, and styrene acrylate copolymer. Examples of the resin component include, in addition to the above-described ones, thermosetting resin such as epoxy resin, phenol resin, melamine resin, and urea resin, and thermoplastic resin such as polyolefin, polyvinyl acetate, polyvinyl chloride, polystyrene, polyamide, polycarbonate, and polyethylene terephthalate.

The sintered magnetic substance sheet is the above-described magnetic substance sintered into a sheet, and for example, a ferrite sheet is used.

The magnetic sheet 4 has a thickness of, for example, 10 μm or more, preferably 50 μm or more, and for example, 500 μm or less, preferably 300 μm or less.

(Housing)

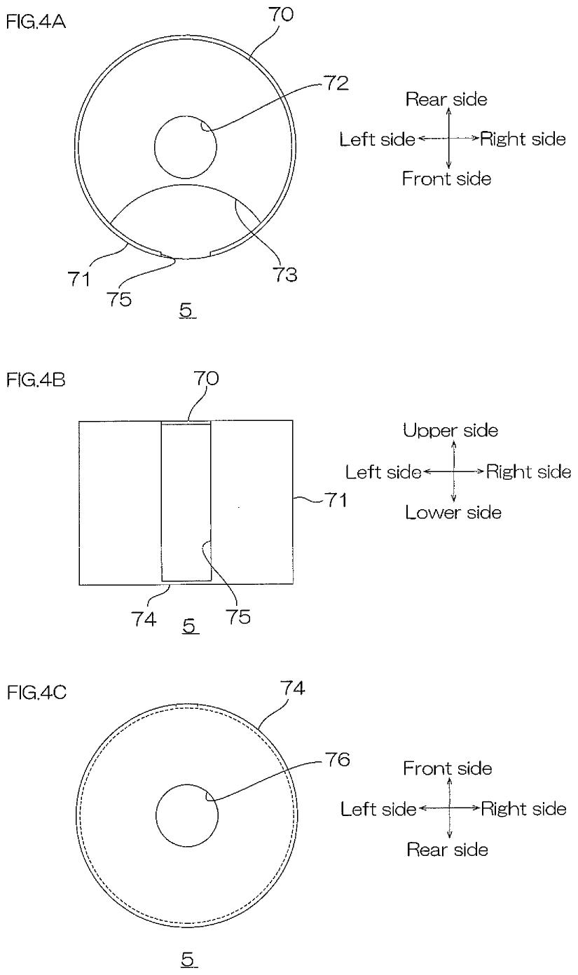

As shown in FIG. 4A to FIG. 4 C and FIG. 1, the housing 5 has a substantially cylindrical shape extending in up-down direction, and includes a lid 70 and a main portion 71.

The lid 70 has a circular plate shape. The lid 70 is formed with an upper face opening 72 as the first opening, and an upper cutout portion 73 as the second opening.

The upper face opening 72 is formed into a substantially circular shape in plan view at a generally center in plan view. The upper face opening 72 is formed so that the upper face of the battery negative electrode terminal 6 is exposed when the secondary battery 2, coil-included board 3, and magnetic sheet 4 are accommodated in the housing 5.

The upper cutout portion 73 is formed at a front side of the upper face opening 72 so as to be cut out into an arc shape. The upper face opening 72 is formed so as to accommodate the negative electrode terminal unit 67 when the secondary battery 2, coil-included board 3, and magnetic sheet 4 are accommodated in the housing 5. That is, the upper cutout portion 73 is formed so as to include the negative electrode terminal unit 67 when projected in up-down direction.

The main portion 71 has a bottom 74, and has a bottomed cylindrical shape with its upper side opened. The main portion 71 is formed so that the upper end edge thereof fits the lid 70.

A slit 75 is formed at a front side face of the main portion 71. The slit 75 is formed to accommodate the first joint base portion 33 when the secondary battery 2, coil-included board 3, and magnetic sheet 4 are accommodated in the housing 5. That is, the slit 75 is formed into a generally rectangular shape extending in up-down direction in side view from the lower end edge to the upper end edge of the front side of the main portion 71.

A bottom opening 76 is formed at the bottom 74 of the main portion 71. The bottom opening 76 is formed into a circular shape in plan view at substantially a center of the bottom 74 in bottom view. The bottom opening 76 is formed so as to expose the external-side circuit positive electrode terminal 23 when the secondary battery 2, coil-included board 3, and magnetic sheet 4 are accommodated in the housing 5.

(Battery pack)

The battery pack 1 assembly is described next.

As shown in FIG. 5, the coil-included board 3 shown in FIG. 2A is bent so that it can be accommodated in the housing 5.

To be specific, in the coil-included board 3 shown in FIG. 2A, the two first bending portions 60 of the first joint base portion 33 are bent to the upper side to form the right angle (fold to form valley), to dispose the negative electrode terminal base portion 31 above the control circuit base portion 30. The two third bending portions 64 of the third joint base portion 35 are bent to the lower side to form the right angle (fold to form mountain), to dispose the coil member 8 below the control circuit base portion 30. Then, the two second bending portions 62 of the second joint base portion 34 are bent to the lower side to form the right angle (fold to form mountain), to dispose the positive electrode terminal base portion 32 below the control circuit base portion 30 and coil member 8.

In this manner, as shown in FIG. 5, a bent circuit 69, in which the positive electrode terminal unit 68, coil member 8, control circuit unit 66, and negative electrode terminal unit 67 are disposed in sequence from the lower side in spaced apart relation from each other, is produced.

In the bent circuit 69, the external-side circuit positive electrode terminal 23 of the positive electrode terminal unit 68, first coil pattern 11 of the coil member 8, control element 21 of the control circuit unit 66, and charging-circuit negative electrode terminal 24 of the negative electrode terminal unit 67 are disposed to face the lower side. The second coil pattern 12 of the coil member 8, and connection wire pattern 25 and battery-side circuit positive electrode terminal 22 of the control circuit unit 66 are disposed to face the upper side.

The positive electrode terminal unit 68, coil member 8, control circuit unit 66, and negative electrode terminal unit 67 are disposed to be parallel in the surface direction, and the first joint base portion 33, second joint base portion 34, and third joint base portion 35 are disposed to extend in up-down direction. At the bending portions (60, 62, 64), as shown in FIG. 8B, the bent-fixing portions (61, 63, 65) are disposed to be inside.

Then, as shown in FIG. 5, the secondary battery 2 is disposed between the control circuit unit 66 and the negative electrode terminal unit 67.

At this time, the secondary battery 2 is disposed so that the battery negative electrode terminal 6 is disposed at the upper side, and the battery positive electrode terminal 7 is disposed at the lower side. To be specific, the secondary battery 2 is disposed between the control circuit unit 66 and the negative electrode terminal unit 67 so that the charging-circuit negative electrode terminal 24 is in contact with the battery negative electrode terminal 6, and the battery-side circuit positive electrode terminal 22 is in contact with the battery positive electrode terminal 7.

Furthermore, the magnetic sheet 4 is disposed between the coil member 8 and the control circuit unit 66.

Then, the bent circuit 69 in which the secondary battery 2 and the magnetic sheet 4 are disposed is accommodated in the main portion 71.

At this time, the bent circuit 69 is accommodated in the main portion 71 so that the slit 75 of the main portion 71 accommodates the first joint base portion 33.

Then, the lid 70 is attached to the main portion 71, and they are fixed.

At this time, the lid 70 is disposed at the main portion 71 so that the negative electrode terminal unit 67 is accommodated in the upper cutout portion 73 of the lid 70 in front-rear direction.

In this manner, as shown in FIG. 1 and FIG. 6A to FIG. 7B, the battery pack 1 is produced.

In the battery pack 1, the secondary battery 2, coil-included board 3, and magnetic sheet 4 are accommodated in the housing 5. To be specific, in the housing 5, the positive electrode terminal unit 68, coil member 8, magnetic sheet 4, control circuit unit 66, secondary battery 2, and negative electrode terminal unit 67 are disposed in sequence from the bottom.

The positive electrode terminal unit 68 is disposed so that the external-side circuit positive electrode terminal 23 is positioned at a lower side. The lower face of the positive electrode terminal unit 68 is in contact with the upper face of the bottom 74 of the housing 5.

The coil member 8 is disposed so that the first coil pattern 11 is positioned at the lower side, and the second coil pattern 12 is positioned at the upper side.

The control circuit unit 66 is disposed so that the control element 21 is positioned at the lower side, and the battery-side circuit positive electrode terminal 22 and connection wire pattern 25 are positioned at the upper side.

The negative electrode terminal unit 67 is disposed at the upper side of the secondary battery 2 so that the charging-circuit negative electrode terminal 24 is positioned at the lower side. The negative electrode terminal unit 67 is disposed to be accommodated in the upper face opening 72. That is, when projected in up-down direction, front-rear direction, and left-right direction, the negative electrode terminal unit 67 is included in the upper face opening 72. The upper face of the negative electrode terminal unit 67 is in contact with the lower face of the lid 70, and the lower face of the negative electrode terminal unit 67 is in contact with the upper face of the battery negative electrode terminal 6. That is, the charging-circuit negative electrode terminal 24 is in contact with the battery negative electrode terminal 6.

The first joint base portion 33 of the coil-included board 3 is disposed at a center in up-down direction of the negative electrode terminal unit 67 and control circuit unit 66 to be accommodated in the slit 75 of the housing 5. That is, when projected in up-down direction, and radial direction (front-rear direction), the first joint base portion 33 is included in the slit 75. The inner face of the first joint base portion 33 is in contact with the front peripheral side of the secondary battery 2.

The second joint base portion 34 is disposed to be in contact with the inner side of the rear end of the main portion 71 at a center in up-down direction of the positive electrode terminal unit 68 and control circuit unit 66.

The third joint base portion 35 is disposed to be in contact with the inner side of the right end of the main portion 71 at a center in up-down direction of the coil member 8 and control circuit unit 66.

The secondary battery 2 is disposed at the upper side of the control circuit unit 66 and lower side of the negative electrode terminal unit 67. The upper face of the secondary battery 2 (battery negative electrode terminal 6) is in contact with the charging-circuit negative electrode terminal 24 of the negative electrode terminal unit 67, and the lower face of the secondary battery 2 (battery positive electrode terminal 7) is in contact with the battery-side circuit positive electrode terminal 22 of the control circuit unit 66. The peripheral side face of the secondary battery 2 is in contact with the inner side of the main portion 71.

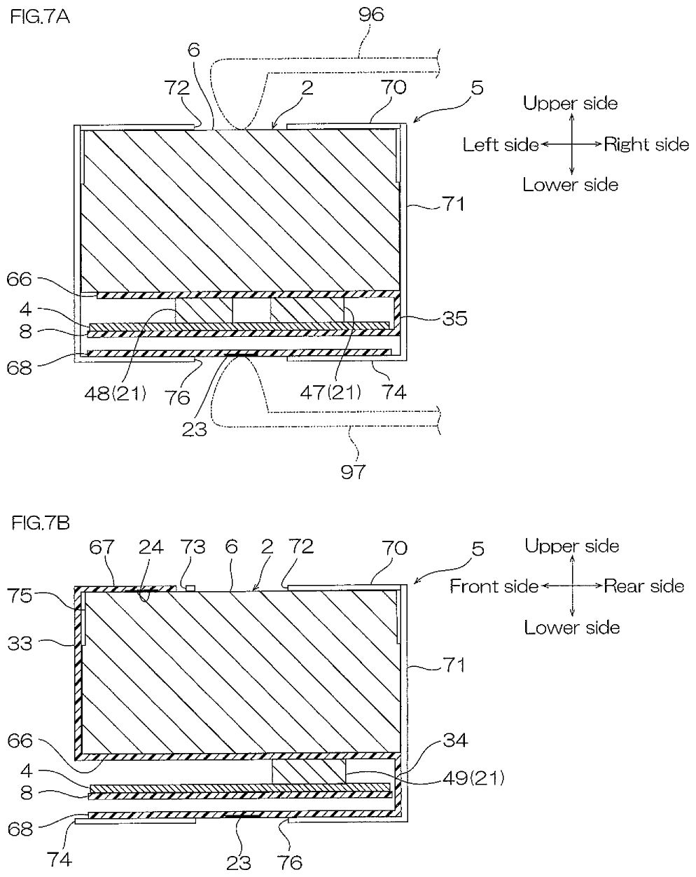

In the battery pack 1, in plan view, substantially a center of the battery negative electrode terminal 6 is exposed through the upper face opening 72, and in bottom view, the external-side circuit positive electrode terminal 23 is exposed through the bottom opening 76. In this manner, as shown by the phantom line of FIG. 7A, in the upper face opening 72, the negative electrode terminal 96 of the external electronic device can directly contact the battery negative electrode terminal 6, and in the bottom opening 76, the positive electrode terminal 97 of an external electronic device can directly contact the battery positive electrode terminal 7.

<Wireless Power Transmission System>

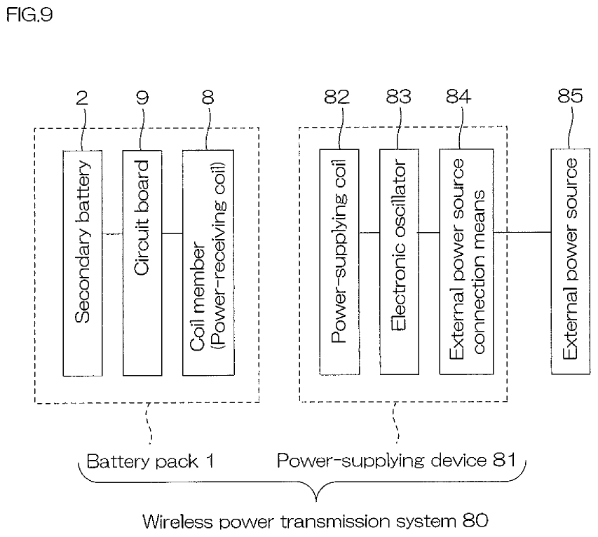

In the following, an embodiment of the wireless power transmission system of the present invention is described with reference to FIG. 9.

The wireless power transmission system 80 includes a battery pack 1 and a power-supplying device 81.

The power-supplying device 81 includes a power-supplying coil 82, electronic oscillator 83, and external power source connector 84.

For the power-supplying coil 82, for example, the above-described coil member 8, and a wound coil formed by winding wire rods such as copper wire is used.

The electronic oscillator 83 is a circuit that generates electric power having a frequency of, for example, 1 MHz or more and 10 MHz or less (preferably 1 MHz or more and 5 MHz or less). The electronic oscillator 83 can be any of those used for an LC electronic oscillator, CR electronic oscillator, liquid crystal electronic oscillator, and switching circuit.

The external power source connector 84 is capable of connecting with the external power source 85, and for example, an AC adapter, and USB terminal are used.

Transmission of the electric power by magnetic field between the coil member 8 (power-receiving coil) and power-supplying coil 82 can be done by any of the magnetic field resonance method and electromagnetic induction method. Preferably, in view of longer transmission distance, and highly efficient electric power transmission even with coil mispositioning, the magnetic field resonance method is used.

<Charge-Discharge Mechanism>

(At the Time of Charging)

The electric power supplied to the electronic oscillator 83 by the external power source 85 is converted to electric power having a frequency of, for example, 1 MHz or more and 10 MHz or less, and with the electric power of that frequency, magnetic field is generated from the power-supplying coil 82. By the magnetic field generated by the power-supplying coil 82, the coil member 8 (power-receiving coil) receives electric power of that frequency.

The received electric power is converted to direct current and controlled to a voltage of a predetermined value or less by the control element 21, and supplied to the secondary battery 2. That is, alternating current of 1 MHz or more and 10 MHz or less is generated at the coil member 8, and the alternating current is converted to the direct current by the rectifier 47 through the first connection wire 50 and second connection wire 51. Then, the direct current reaches the charge controller 48 through the third connection wire 52. Thereafter, the direct current controlled by the charge controller 48 reaches the battery positive electrode terminal 7 of the secondary battery 2 through the fourth connection wire 53, and battery-side circuit positive electrode terminal 22. Meanwhile, at the negative electrode side, the electric current reaches the charge controller 48 from the battery negative electrode terminal 6 (ground) of the secondary battery 2 through the charging-circuit negative electrode terminal 24 and ninth connection wire 58.

In this manner, the secondary battery 2 is charged.

(At the Time of Discharging)

Electric current having a predetermined voltage (for example, 3.7 V) is discharged from the battery positive electrode terminal 7 of the secondary battery 2, and the electric current reaches the transformer 49 through the battery-side circuit positive electrode terminal 22 and sixth connection wire 55. Then, the electric current having a predetermined voltage is transformed to a desired voltage (for example, 1.2 V) by a transformer 49. Thereafter, the transformed electric current reaches the positive electrode terminal (for example, external device positive electrode terminal 97 to be described later) of the external electronic device (for example, hearing aid 90 to be described later) through the seventh connection wire 56 and external-side circuit positive electrode terminal 23. Meanwhile, at the negative electrode side, the battery negative electrode terminal 6 of the secondary battery 2 is in direct contact with the negative electrode terminal (for example, external device negative electrode terminal 96 to be described later) of the external electronic device, and therefore the electric current directly reaches the battery negative electrode terminal 6 (ground) from the external electronic device, and then the electric current reaches the transformer 49 through the charging-circuit negative electrode terminal 24 and tenth connection wire 59.

In this manner, the secondary battery 2 is discharged to drive the external electronic device.

(Use)

The battery pack 1 and wireless power transmission system 80 can be widely used for electronic devices in which conventional secondary batteries and primary batteries are used. Examples of the electronic device include wearable devices such as hearing aids, smart glasses, and smart watches, and speakers and medical devices.

The battery pack 1 includes the secondary battery 2 with the battery negative electrode terminal 6 disposed at the upper face and the battery positive electrode terminal disposed at the lower side, and also includes the coil member 8, the circuit board 9, and the housing 5; and the battery negative electrode terminal 6 is exposed to the outside of the housing 5.

Therefore, when the external electronic device is attached to the battery pack 1, the negative electrode terminal of the external electronic device can directly contact the battery negative electrode terminal 6 of the battery pack 1, and by electrically connecting these, the external electronic device can be driven. That is, in the battery pack 1, a terminal (external-side circuit negative electrode terminal) that makes contact with the negative electrode terminal of the external electronic device does not have to be provided separately, and the thickness (up-down direction distance) for that terminal can be eliminated. Thus, the size of the battery pack 1 is small in the thickness direction.

In the battery pack 1, the coil member 8 is a sheet coil including the first insulating base layer 10, and coiled wire 17.

Therefore, the thickness is smaller in up-down direction (thickness direction) compared with the case of the wound coil. Therefore, a smaller size can be achieved even more.

In the battery pack 1, the circuit board 9 is a flexible wired circuit board including the control element 21.

Therefore, the circuit board 9 can be freely disposed in the housing 5 in conformity to the shapes of the housing 5 and secondary battery 2, and the space in the housing 5 can be efficiently used. Therefore, a smaller size can be achieved even more.

The battery pack 1 includes the magnetic sheet 4 between the coil member 8 and circuit board 9.

Therefore, when the coil member 8 receives electric power externally, the electric power can be converged to the coil member 8. Therefore, electric power receiving efficiency can be improved.

In the battery pack 1, the housing 5 has an upper face opening 72 positioned at the upper side of the secondary battery 2.

Therefore, through the upper face opening 72, the battery negative electrode terminal 6 can be exposed to the outside of the battery pack 1. Thus, in the upper face opening 72, the negative electrode terminal (FIG. 7A, reference numeral 96) of the external electronic device can be reliably made into contact with the battery negative electrode terminal 6.

In the battery pack 1, the circuit board 9 includes the battery-side circuit positive electrode terminal 22 and charging-circuit negative electrode terminal 24.

Therefore, the secondary battery 2 can be reliably charged through the battery-side circuit positive electrode terminal 22 and charging-circuit negative electrode terminal 24.

In the battery pack 1, the lid 70 has the upper cutout portion 73 positioned at the upper side of the secondary battery 2.

Therefore, the charging-circuit negative electrode terminal 24 can be accommodated in the upper cutout portion 73. Thus, the charging-circuit negative electrode terminal 24 does not have to be provided at the upper side of the lid 70. Therefore, a thinner size can be achieved even more.

In the battery pack 1, the circuit board 9 includes the external-side circuit positive electrode terminal 23, and the housing 5 has the bottom opening 76.

Therefore, when the external electronic device is attached to the battery pack 1, the positive electrode terminal (FIG. 7A, reference numeral 97) of the external electronic device can be reliably made in direct contact with the battery positive electrode terminal 7 in the bottom opening 76. In this manner, they are electrically connected to drive the external electronic device.

In the battery pack 1, the main portion 71 has the slit 75 positioned at the side of the secondary battery 2.

Therefore, the first joint base portion 33 can be accommodated in the slit 75. Thus, the internal diameter of the main portion 71 can be made smaller, and a smaller size can be achieved even more. Furthermore, the stress due to the expansion in radial direction at the time of charging and discharging of the secondary battery 2 can be released with the slit 75, and damages to the housing 5 can be suppressed.

In the battery pack 1, the bent-fixing portion (first bent-fixing portion 61, second bent-fixing portion 63, and third bent-fixing portion 65) is disposed at the bending portion (first bending portion 60, second bending portion 62, and third bending portion 64). Therefore, when the joint base portion (first joint base portion 33, second joint base portion 34, third joint base portion 35) is bent at the bending portion, the bent-fixing portion keeps the bent shape. Therefore, the joint base portion can be suppressed from restoring its original shape, and the bent shape of the coil-included board 3 can be reliably kept.

The wireless power transmission system 80 includes the battery pack 1, and the power-supplying device 81 including the power-supplying coil 82.

Therefore, electric power can be transmitted wirelessly to the secondary battery 2 of the battery pack 1, and therefore the secondary battery 2 can be wirelessly charged.

In the wireless power transmission system 80, the power-supplying device 81 transmits electric power having a frequency of 1 MHz or more and 10 MHz or less.

Therefore, the battery pack 1 can receive electric power with a high frequency of 1 MHz or more and 10 MHz or less, and the secondary battery 2 can be highly efficiently charged.

<Hearing Aid>

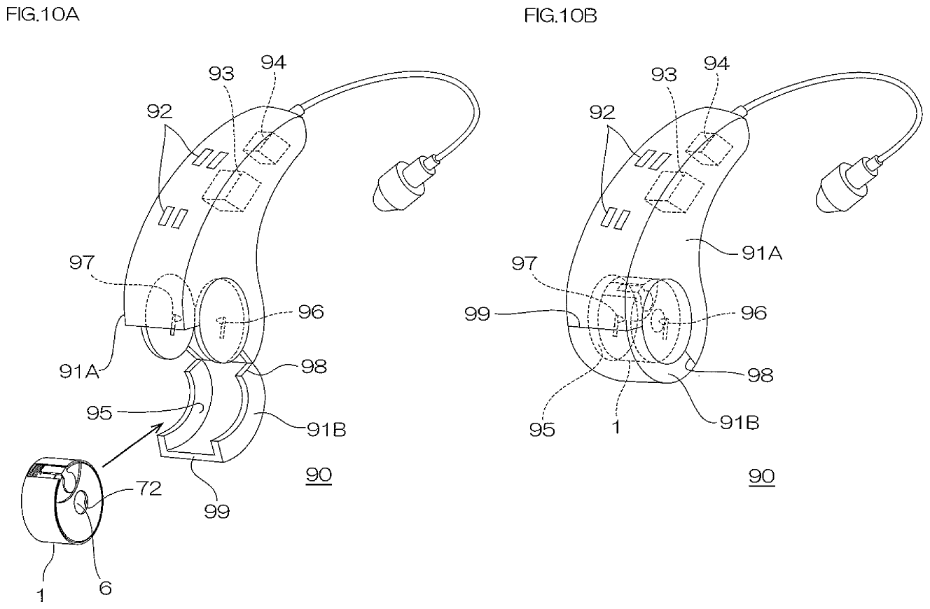

Next, with reference to FIG. 10A and FIG. 10B, an embodiment of the hearing aid of the present invention is described.

The hearing aid 90 includes the battery pack 1, a hearing aid housing 91, microphone 92, amplifier 93, speaker 94, external device negative electrode terminal 96, and external device positive electrode terminal 97.

For the transformer 49 mounted on the battery pack 1 for the hearing aid 90, a transformer capable of converting to 1.2V is used.

The hearing aid housing 91 has a housing main portion 91A and an open-close mechanism 91B.

The housing main portion 91A accommodates a microphone 92, amplifier 93, speaker 94, external device negative electrode terminal 96, and external device positive electrode terminal 97 therein.

The external device negative electrode terminal 96 and external device positive electrode terminal 97 are disposed to face each other in spaced apart relation at the lower side of the housing main portion 91A. The space between the distal end (contact portion with battery pack 1) of the external device negative electrode terminal 96 and the distal end of the external device positive electrode terminal 97 is substantially the same as the up-down direction length of the battery pack 1 (ref: FIG. 1).

The microphone 92, amplifier 93, and speaker 94 are disposed inside the hearing aid housing 91, and they are electrically connected with the external device negative electrode terminal 96 and external device positive electrode terminal 97.

The open-close mechanism 91B is disposed at the lower end of the housing main portion 91A. The open-close mechanism 91B is a curved plate member having an arc shape in side view and letter-U shape in front view, and one end (fixed end portion) 98 of the open-close mechanism 91B is fixed rotatably at the lower end of the housing main portion 91A through a hinge portion. The open-close mechanism 91B forms an accommodation unit 95 along with space between the external device negative electrode terminal 96 and external device positive electrode terminal 97.

The accommodation unit 95 has a space that can accommodate the battery pack 1. The accommodation unit 95 is configured to accommodate selectively the battery pack 1, or a commercially available primary battery (preferably, button type primary battery).

The accommodation unit 95 is accommodated inside the hearing aid housing 91, or exposed to the outside thereof by rotating the open-close mechanism 91B with the fixed end portion 98 as the supporting point. To be specific, as shown in FIG. 10A, the accommodation unit 95 is exposed to the outside (opened state) by moving a free end 99 (the other end opposite to the fixed end portion 98) of the open-close mechanism 91B to the lower side. Meanwhile, as shown in FIG. 10B, by moving the free end 99 to the upper side, the accommodation unit 95 is accommodated inside the hearing aid housing 91 (closed state).

When the open-close mechanism 91B is in opened state, the upper portion of the accommodation unit 95 is opened, and the battery pack 1 can be replaced. Meanwhile, when the open-close mechanism 91B is in closed state, the size and the shape inside the accommodation unit 95 is substantially the same as those of the battery pack 1.

The battery pack 1 is accommodated in the accommodation unit 95. To be specific, as shown in FIG. 10B, the battery pack 1 is disposed inside the accommodation unit 95 so that, when the open-close mechanism 91B is in closed state, the external device negative electrode terminal 96 passes through the upper face opening 72 to make contact with the battery negative electrode terminal 6, and the external device positive electrode terminal 97 passes through the bottom opening 76 to make contact with the external-side circuit positive electrode terminal 23.

The hearing aid 90 includes the battery pack 1, hearing aid housing 91, microphone 92, amplifier 93, and speaker 94. Therefore, the accommodation unit 95 of the hearing aid 90 is a small size, reducing the size of the hearing aid 90.

In the hearing aid 90, the accommodation unit 95 can also accommodate a primary battery. Therefore, it can be driven by any of the primary battery and secondary battery, and therefore it is convenient.

### Modified Example

(1) In the embodiment shown in FIG. 1, the battery pack 1 includes the coil-included board 3 in which the coil member 8 and circuit board 9 are integrally formed, but for example, although not shown, the coil member 8 and circuit board 9 can be formed from a separate component.

In this embodiment, the coil member 8 includes a plurality of (two) terminals for electrically connecting with the circuit board 9, and the circuit board 9 includes a plurality of (two) terminals for electrically connecting with the coil member 8. Then, these terminals are electrically connected and accommodated in the housing 5.

(2) In the embodiment shown in FIG. 1, the circuit board 9 includes, as the control element 21, the rectifier 47, charge controller 48, and transformer 49, but for example, although not shown, the circuit board 9 can also include an element that comprehensively has two or three of the rectifier 47, charge controller 48, and transformer 49 as one component (for example, integrated circuit). Also, the circuit board 9 further can include, as the control element 21, another element such as a condenser for suppressing noises. The connection wire pattern 25 and base via portions 36 to 45 are suitably changed in accordance with the types and number of the control element 21. To be specific, for example, when one component that works as the rectifier 47, charge controller 48, and transformer 49 is used (control element 21), the fifth connection wire 54, ninth connection wire 58, and tenth connection wire 59 are used as one connection wire, and through these connection wires, the charging-circuit negative electrode terminal 24 can be electrically connected with the control element 21.

(3) In the embodiment shown in FIG. 1 and FIG. 9, the battery pack 1 and the wireless power transmission system 80 includes the magnetic sheet 4, but for example, although not shown, the battery pack 1 and wireless power transmission system 80 may not include the magnetic sheet 4.

In view of electric power receiving efficiency, preferably, the battery pack 1 and wireless power transmission system 80 include the magnetic sheet 4.

(4) In the embodiment shown in FIG. 2A to FIG. 2B and FIG. 8A to FIG. 8B, a plurality of (two) first bending portions 60, second bending portions 62, and third bending portions 64 are formed at each of the joint portions (33 to 35). However, the number of the bending portion (60, 62, 64) can be one per each, or can be three or more. A plurality of (two) first bent-fixing portions 61, second bent-fixing portions 63, or third bent-fixing portions 65 are provided at each of the bending portion (60, 62, 64). However, the number of the bent-fixing portion (61, 63, 65) can be one per each, or can be three or more.

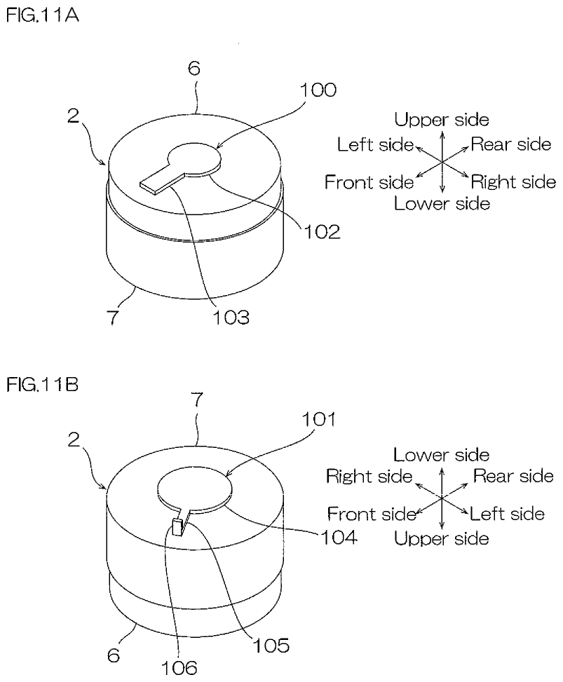

(5) In the embodiment shown in FIG. 1 and FIG. 5, the secondary battery 2 used in the battery pack 1 does not include the negative electrode tab and positive electrode tab. However, for example, as shown in FIG. 11A to FIG. 13, the secondary battery 2 can include the negative electrode tab 100 and positive electrode tab 101. That is, the secondary battery 2 can be a tabbed battery.

As shown in FIGS. 11A-B, the negative electrode tab 100 is provided at the upper face of the secondary battery 2, and has a flat plate shape. The negative electrode tab 100 integrally includes a center portion 102 having a generally circular shape in plan view, and an extended portion 103 extending linearly from the center portion 102 to the outside in radial direction (front side). The negative electrode tab 100 is disposed at the upper face of the secondary battery 2 so that the center portion 102 overlaps with the center of the battery negative electrode terminal 6 when projected in the thickness direction.

The positive electrode tab 101 is provided at the lower face of the secondary battery 2, and has a flat plate shape. The positive electrode tab 101 integrally includes a center portion 104 having a generally circular shape in plan view, an extended portion 105 extending linearly from the center portion 104 to the outside in the radial direction (left front side), and a projected portion 106 slightly extending from one end edge of the extended portion 105 to the lower side. The positive electrode tab 101 is disposed at the lower face of the battery 2 so that the projected portion 106 extends toward the lower side, and when projected in the thickness direction, the center portion 104 overlaps with the center of the battery positive electrode terminal 7.

The negative electrode tab 100 and positive electrode tab 101 are fixed at the upper face and lower face of the secondary battery 2 by, for example, welding.

The negative electrode tab 100 and positive electrode tab 101 are formed from a metal component. Examples of the metal component material include conductive metals including copper, silver, gold, nickel, and alloys thereof.

In the tabbed secondary battery, the negative electrode tab 100 and positive electrode tab 101 work as the battery negative electrode terminal and battery positive electrode terminal, and are a portion of the battery negative electrode terminal 6 and battery positive electrode terminal 7.

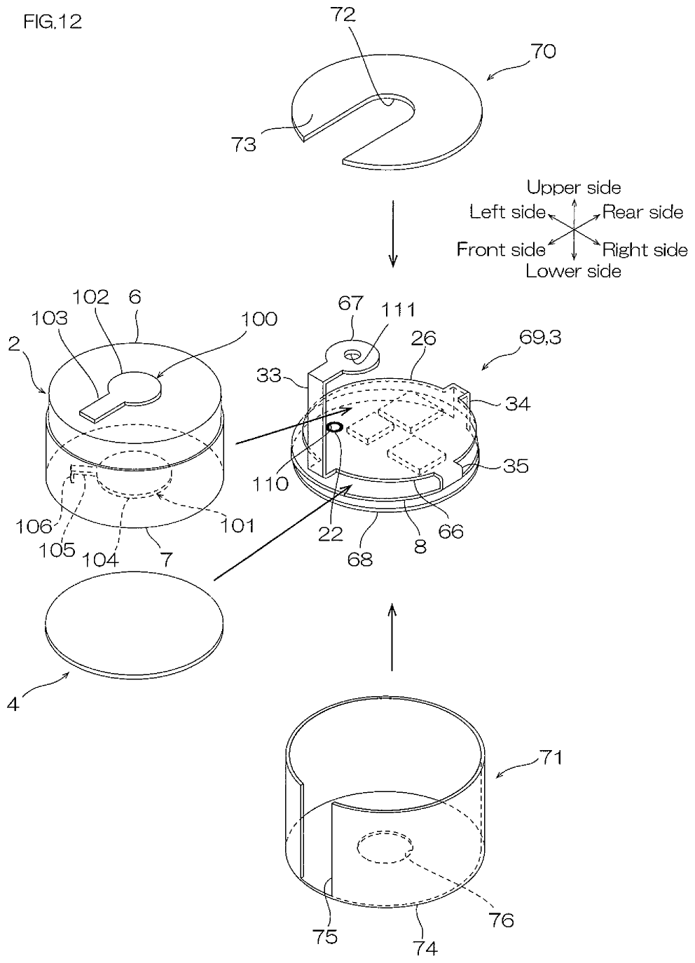

In this embodiment, as shown in FIG. 12, at the control circuit unit 66, a positive electrode terminal opening 110 penetrating the center in plan view of the battery-side circuit positive electrode terminal 22 and the second insulating base layer 20 contacting therewith in thickness direction is formed. At the negative electrode terminal unit 67, the negative electrode terminal opening 111 penetrating the center in plan view of the charging-circuit negative electrode terminal 24 and the second insulating base layer 20 contacting therewith in the thickness direction is formed.

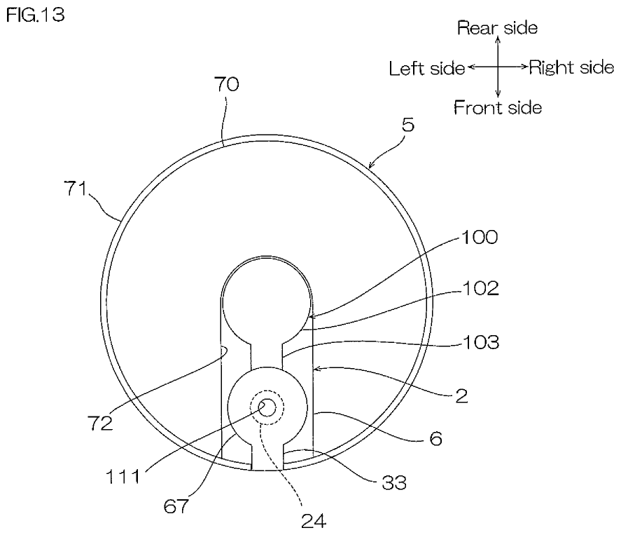

As shown in FIG. 13, an upper face opening 72 is formed at the lid 70 of the housing 5. The upper face opening 72 is formed by cutting out the lid 70 into a substantially U-shape from the front end edge to the generally center in plan view. The upper face opening 72 is formed so as to expose the negative electrode tab 100 and the negative electrode terminal unit 67 when the secondary battery 2, coil-included board 3, and magnetic sheet 4 are accommodated in the housing 5. That is, the upper face opening 72 is formed to include the negative electrode tab 100 and negative electrode terminal unit 67 when projected in up-down direction.

In this embodiment, the secondary battery 2 and coil-included board 3 are electrically connected by an electrically conductive bonding material such as solder in assembly of the battery pack 1. To be specific, the secondary battery 2 and coil-included board 3 are disposed so that the upper face of the extended portion 103 of the negative electrode tab 100 is in contact with the charging-circuit negative electrode terminal 24, and the projected portion 106 of the positive electrode tab 101 is inserted into the positive electrode terminal opening 110. Then, the positive electrode terminal opening 110 and negative electrode terminal opening 111 are filled with an electrically conductive bonding material such as solder.

In this embodiment, the thickness of the negative electrode tab 100 or lid 70 is adjusted so that the position of the upper face of the negative electrode tab 100 in up-down direction is the same with or lower than the position of the upper face of the lid 70 in up-down direction at the negative electrode tab 100 exposed through the negative electrode terminal opening 111.

The same operations and effects as those in the embodiment shown in FIG. 1 can be achieved in this embodiment as well.

While the illustrative embodiments of the present invention are provided in the above description, such is for illustrative purpose only and it is not to be construed as limiting in any manner. Modification and variation of the present invention that will be obvious to those skilled in the art is to be covered by the following claims.

### INDUSTRIAL APPLICABILITY

The battery pack and wireless power transmission system of the present invention can be applied in various industrial products, and for example, can be suitably used for wearables such as hearing aid, smart glasses, and smart watches, and speakers and medical devices.

### DESCRIPTION OF REFERENCE NUMERALS

1 battery pack
2 secondary battery
3 coil-included board
4 magnetic sheet
5 housing
6 battery negative electrode terminal
7 battery positive electrode terminal
8 coil member
9 circuit board
10 first insulating base layer
11 first coil pattern
12 second coil pattern
17 wire
21 control element
22 battery-side circuit positive electrode terminal
24 charging-circuit negative electrode terminal
72 upper face opening
73 upper cutout portion
80 wireless power transmission system
81 power-supplying device
82 power-supplying coil
90 hearing aid
91 hearing aid housing
92 microphone
93 amplifier
94 speaker
95 accommodation unit

1. A battery pack comprising:
a secondary battery having a battery negative electrode terminal disposed at one side in thickness direction of the secondary battery and a battery positive electrode terminal disposed at the other side in thickness direction of the secondary battery,
a coil member,
a circuit board electrically connected with the battery negative electrode terminal, the battery positive electrode terminal, and the coil member, and
a housing accommodating the secondary battery, the coil member, and the circuit board,
wherein the battery negative electrode terminal is exposed to the outside of the housing.

2. The battery pack according to claim 1, wherein
the coil member is a sheet coil including an insulating layer and a coiled wire disposed on at least one surface of the insulating layer.

3. The battery pack according to claim 1, wherein
the circuit board is a flexible wired circuit board including a control element.

4. The battery pack according to claim 1, further comprising a magnetic sheet disposed between the coil member and the circuit board.

5. The battery pack according to claim 1, wherein
the housing has a first opening to expose the battery negative electrode terminal at one side in thickness direction of the secondary battery.

6. The battery pack according to claim 1, wherein
the circuit board further comprises
a first circuit terminal that is electrically connected with the battery positive electrode terminal, and
a second circuit terminal that is electrically connected with the battery negative electrode terminal.

7. The battery pack according to claim 6, wherein
the housing has a second opening for accommodating the second circuit terminal at one side in thickness direction of the secondary battery.

8. A wireless power transmission system comprising:
the battery pack according to claim 1, and
a power-supplying device including a power-supplying coil.

9. The wireless power transmission system according to claim 8, wherein
the power-supplying device transmits electric power with a frequency of 1 MHz or more and 10 MHz or less.

10. A hearing aid comprising:
the battery pack according to claim 1,
a hearing aid housing having an accommodation unit that accommodates the battery pack, and
a microphone, amplifier, and speaker provided inside the hearing aid housing.

11. The hearing aid according to claim 10, wherein
the accommodation unit is capable of accommodating a primary battery.
